(19) United States
(12) Patent Application Publication
(10) Pub. No.: US 2012/0216163 A1
(43) Pub. Date: Aug. 23, 2012

(54) TIMING ANALYSIS METHOD, TIMING ANALYSIS APPARATUS, AND NON-TRANSITORY COMPUTER READABLE MEDIUM STORING TIMING ANALYSIS PROGRAM

(75) Inventors: Takanobu URA, Kanagawa (JP); Kazuyuki IRIE, Kanagawa (JP)

(73) Assignee: RENESAS ELECTRONICS CORPORATION, Kawasaki-shi (JP)

(21) Appl. No.: 13/354,535

(22) Filed: Jan. 20, 2012

(30) Foreign Application Priority Data
Feb. 23, 2011 (JP) 2011-37142

(51) Int. Cl. G06F 17/50

(52) U.S. Cl. 716/113

(57) ABSTRACT

A timing analysis method includes performing voltage drop analysis of a circuit laid out on a semiconductor chip, creating a voltage drop region file representing voltage drop on the semiconductor chip as regions at given voltage ranges based on a result of the voltage drop analysis, calculating second OCV factors respectively corresponding to the given voltage ranges contained in the voltage drop region file for each of the regions by using an OCV factor file containing first OCV factors representing variation of delay in association with given voltages in consideration of voltage drop, creating an OCV region file containing the calculated second OCV factors and the regions in association with each other, performing delay calculation of the laid-out circuit by using a delay library, and performing timing analysis by using the delay calculation result and the second OCV factors for each of the regions contained in the OCV region file.

### CROSS-REFERENCE TO RELATED APPLICATIONS

This application is based upon and claims the benefit of priority from Japanese patent application No. 2011-37142, filed on Feb. 23, 2011, the disclosure of which is incorporated herein in its entirety by reference.

### BACKGROUND

The present invention relates to a timing analysis method, a timing analysis apparatus, and a non-transitory computer readable medium storing a timing analysis program in which power supply voltage drop is taken into account in semiconductor design.

In recent semiconductor design, delay degradation has become significant due to the effect of power supply voltage drop (which may be referred to hereinafter as “IR-Drop”) caused by finer design rules and larger scale of semiconductor devices. It is therefore essential to take IR-Drop into account in timing design. Further, when performing timing verification with the effect of IR-Drop taken into consideration, the processing time needed for the timing verification increases because timing constraints are severe due to speeding up of semiconductor devices.

The processing time needed for timing analysis has a significant impact on the product development period. Therefore, in order to reduce product development costs, it is strongly demanded to enhance the speed of the timing analysis with the effect of IR-Drop taken into account.

For example, Japanese Unexamined Patent Application Publication No. 2008-112268 discloses a timing verification method aimed at reducing the processing time of the timing analysis with IR-Drop taken into account. This method is a technique aiming at reducing the processing time needed for IR-Drop analysis, and, at the time of repeating timing error correction by ECO, it performs timing analysis using a created voltage drop list in the processing performed for the first time, and performs timing analysis using the updated voltage drop list in the processing performed for the second time or later. The method thereby achieves reduction of the processing time with no degradation of accuracy.

### SUMMARY

As a process flow to perform the timing analysis, a timing analysis process flow including a step of performing delay calculation and a step of performing timing verification (STA) is known (cf. e.g. Hideyuki Kikuchihara, Masahiro Kurimoto, Masahisa Tashiro, Hidekazu Kikuchi, and Masanaga Horikawa, “Timing Closure Technique Considering Signal Integrity”, OKI Technical Review, October 2003, Issue 196, Vol. 70, No. 4).

Further, as one of the most typical delay calculation methods, a method of using a cell delay library containing description of cell delay time is known (cf. e.g. Japanese Unexamined Patent Application Publication No. H11-259555). This method is intended for delay calculation of a cell-based integrated circuit. In the cell delay library, a table containing input waveform slowdown of cell delay time (i.e. input signal slew) and/or dependence on a load capacity is typically stored. According to this method, when a net list of an integrated circuit for which calculation is performed is given, the delay time of each of the cells integrated in the target integrated circuit is acquired by table lookup of the cell delay library, and delay calculation of a target part is performed based on the acquired delay time of each cell.

However, in regard to the technique of performing delay calculation using the delay library, in the case of performing the delay, calculation by taking IR-Drop into account, it is necessary to read the delay library at at least two different voltages and perform delay calculation for the voltage at each instance. Because delay is calculated by interpolating a delay value at the voltage value of an instance, a long processing time is required. There is thus a problem that a long processing time is needed for delay calculation because a plurality of delay libraries are required in the delay calculation.

This problem is specifically described hereinbelow, taking the timing verification method disclosed in Japanese Unexamined Patent Application Publication No. 2008-112268 as an example.

FIG. 11 shows a timing analysis process flow according to the timing verification method disclosed in Japanese Unexamined Patent Application Publication No. 2008-112268. As shown in FIG. 11, the timing analysis process flow includes a step of performing delay calculation (Step S801) and a step of performing STA (Static Timing Analysis) (Step S802) (refer to the paragraph 0028 and the like of Japanese Unexamined Patent Application Publication No. 2008-112268). Further, in FIG. 11, an instance-by-instance IR-Drop value list (F110) is created prior to the delay calculation in order to reflect the effect of IR-Drop on the timing verification.

In regard to the delay calculation in Step S801, although its details are not described in Japanese Unexamined Patent Application Publication No. 2008-112268, it is presumable that a net list file (F101), a SPEF file (F103), a delay library (F105), and an instance-by-instance IR-Drop value list (F110) are input, and delay calculation to calculate the delay value of an instance and the delay value of a line is performed.

As described above, according to a typical delay calculation method using the delay library (Japanese Unexamined Patent Application Publication No. 1411-259555 etc.), delay calculation is performed under voltage conditions of the delay library. Therefore, if the same delay calculation method is adopted in the timing verification method disclosed in Japanese Unexamined Patent Application Publication No. 2008-112268, it is necessary to prepare the delay library used in Step S801 according to the unit of voltages of instances written in the instance-by-instance IR-Drop value list (F110). As a result, a large number of delay libraries are necessary and further a large number of delay libraries need to be read in the delay calculation of Step S801. It is thus necessary in the delay calculation of Step S801 to read the delay libraries at at least two different voltages, perform delay calculation at each voltage value, and calculates a delay value at the voltage value of an instance by interpolation. Accordingly, a long processing time is needed for the delay calculation performed in Step S801.

The present invention has been accomplished in light of the foregoing, and it is desirable to provide a timing analysis method, a timing analysis apparatus, and a non-transitory computer readable medium storing a timing analysis program which can reduce the processing time needed for delay calculation and thereby reduce the processing time needed for timing analysis as a whole.

A first aspect of the present invention is a timing analysis method including a voltage drop analysis step of performing voltage drop analysis of a circuit laid out on a semiconductor chip, a voltage drop region file creation step of creating a voltage drop region file representing voltage drop on the semiconductor chip as regions at given voltage ranges based on a result of the voltage drop analysis, a variation region file creation step of calculating second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other, a delay calculation step of performing delay calculation of the laid-out circuit by using a delay library, and a timing analysis step of performing timing analysis of the laid-out circuit by using a result of the delay calculation and the second variation factors for each of the regions contained in the variation region file.

A second aspect of the present invention is a timing analysis apparatus including a voltage drop analysis unit that performs voltage drop analysis of a circuit laid out on a semiconductor chip, a voltage drop region file creation unit that creates a voltage drop region file representing voltage drop on the semiconductor chip as regions at given voltage ranges based on a result of the voltage drop analysis, a variation region file creation unit that calculates second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other, a delay calculation unit that performs delay calculation of the laid-out circuit by using a delay library, and a timing analysis unit that performs timing analysis of the laid-out circuit by using a result of the delay calculation and the second variation factors for each of the regions contained in the variation region file.

A third aspect of the present invention is a non-transitory computer readable medium storing a timing analysis program that causes a computer to execute a process including performing voltage drop analysis of a circuit laid out on a semiconductor chip, creating a voltage drop region file representing voltage drop on the semiconductor chip as regions at given voltage ranges based on a result of the voltage drop analysis, calculating second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other, performing delay calculation of the laid-out circuit by using a delay library, and performing timing analysis of the laid-out circuit by using a result of the delay calculation and the second variation factors for each of the regions contained in the variation region file.

According to the present invention, it is possible to provide a timing analysis method, a timing analysis apparatus, and a non-transitory computer readable medium storing a timing analysis program which can reduce the processing time needed for delay calculation and thereby reduce the processing time needed for timing analysis as a whole.

### BRIEF DESCRIPTION OF THE DRAWINGS

The above and other aspects, advantages and features will be more apparent from the following description of certain embodiments taken in conjunction with the accompanying drawings, in which:

FIG. 1 is a view showing an example of a computer system configuration for implementing a timing analysis apparatus according to a first embodiment;

FIG. 2 is a flowchart showing a procedure of timing analysis by the timing analysis apparatus according to the first embodiment;

FIG. 3 is a view showing an output example of an IR-Drop analysis result file according to the first embodiment;

FIG. 4 is a view conceptually representing information contained in the IR-Drop analysis result file according to the first embodiment as regions on a semiconductor chip;

FIG. 5 is a view showing an output example of a voltage drop region file according to the first embodiment;

FIG. 6 is a view conceptually representing information contained in the voltage drop region file according to the first embodiment as regions on a semiconductor chip;

FIG. 7 is a view showing an example of an OCV factor file according to the first embodiment;

FIG. 8 is a view showing an output example of an OCV region file according to the first embodiment;

FIG. 9 is a flowchart showing a more detailed procedure of delay calculation and STA processing of region-by-region OCV according to the first embodiment;

FIG. 10 is a flowchart showing a more detailed procedure of STA processing according to the first embodiment; and

FIG. 11 is a view to describe an issue of the present invention.

### DETAILED DESCRIPTION

### First Embodiment

An embodiment of the present invention is described hereinafter with reference to the drawings. The following description and the attached drawings are appropriately shortened and simplified to clarify the explanation. In the drawings, the identical reference symbols denote identical structural elements and the redundant explanation thereof is omitted.

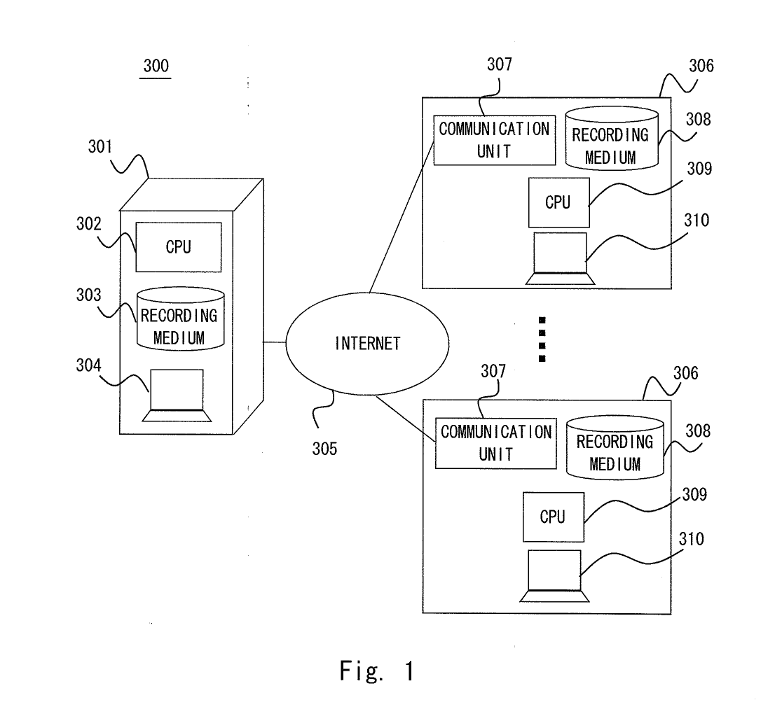

A timing analysis method, a timing analysis apparatus and a timing analysis program according to the embodiment are described hereinafter with reference to FIGS. 1 to 10.

First, the hardware configuration of the timing analysis apparatus according to the embodiment is described with reference o FIG. 1.

FIG. 1 is a view showing an example of a computer system configuration for implementing a timing analysis apparatus according to the embodiment. Referring to FIG. 1, a computer system 300 includes a server 301, a network 305, and a plurality of computer devices 306.

First, the network 305 connects communication between the computer devices 306 and the server 301. For example, a various kind of networks including wired communication and wireless communication such as a mobile communication network, a leased line network, and a LAN(Local Area Network), or a network in which those networks are connected to each other may be applied to the network 305.

The server 301 includes a processing unit 302 composed of a CPU (Central Processing Unit), a recording medium 303, and an input-output unit 304 serving as an input-output interface.

Further, in the server 301, an executable program for implementing the timing analysis apparatus according to the embodiment and data such as net list data and instance information are stored in the recording medium 303. The executable program includes a program for timing analysis (timing analysis program), which is described later. The recording medium 303 is produced using a storage device such as a hard disk, RAM (Random Access Memory) or ROM (Read Only Memory).

Further, in the server 301, the processing unit 302 reads and executes an executable program for implementing the functions of the server 301 which is stored in the recording medium 303, thereby implementing the functions of the server 301. Note that the executable programs and data are stored into the recording medium 303 from the outside using the input-output unit 304 such as a keyboard, mouse or LCD (Liquid Crystal Display) by an administrator of the server 301. In such a configuration, the server 301 can provide the executable program and data to the computer devices 306 through the network 305.

Each computer device 306 includes a communication unit 307, a recording medium 308, a processing unit 309 composed of a CPU, and an input-output unit 310 serving as an input-output interface.

Further, the computer device 306 executes a generation system for implementing the timing analysis apparatus according to the embodiment. The computer device 306 may be a general-purpose computer such as a personal computer, for example. The computer device 306 includes the communication unit 307 and is capable of communicating with the server 301 through the network 305. The computer device 306 connects to the server 301 through the network 305, acquires the executable program for implementing the timing analysis apparatus according to the embodiment and data, and stores them into the recording medium 308.

In the computer device 306, the processing unit 309 reads and executes an executable program for implementing the functions of the computer device 306 which is stored in the recording medium 308, thereby implementing the functions of the computer device 306. Note that the computer device 306 includes the input-output unit 310 which serves as an input-output interface with a user of the computer device 306. The input-output unit 310 is composed of a keyboard, mouse or LCD (Liquid Crystal Display).

It should be noted that the executable program of the timing analysis apparatus according to the embodiment is not limited to the form stored in the recording medium 303 of the server 301. The executable program can be stored and provided to the computer device 306 using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Compact Disc-Read Only Memory), CD-R (Compact Disc-Recordable), CD-R/W (Compact Disc-ReWritable), and semiconductor memories (such as mask ROM, PROM (programmable ROM), EPROM (Erasable PROM), flash ROM, RAM (Random Access Memory), etc.). The executable program may be provided to the computer device 306 using any type of transitory computer readable media. Examples of transitory computer readable media include electric signals, optical signals, and electromagnetic waves. Transitory computer readable media can provide the executable program to the computer device 306 via a wired communication line (e.g. electric wires, and optical fibers) or a wireless communication line.

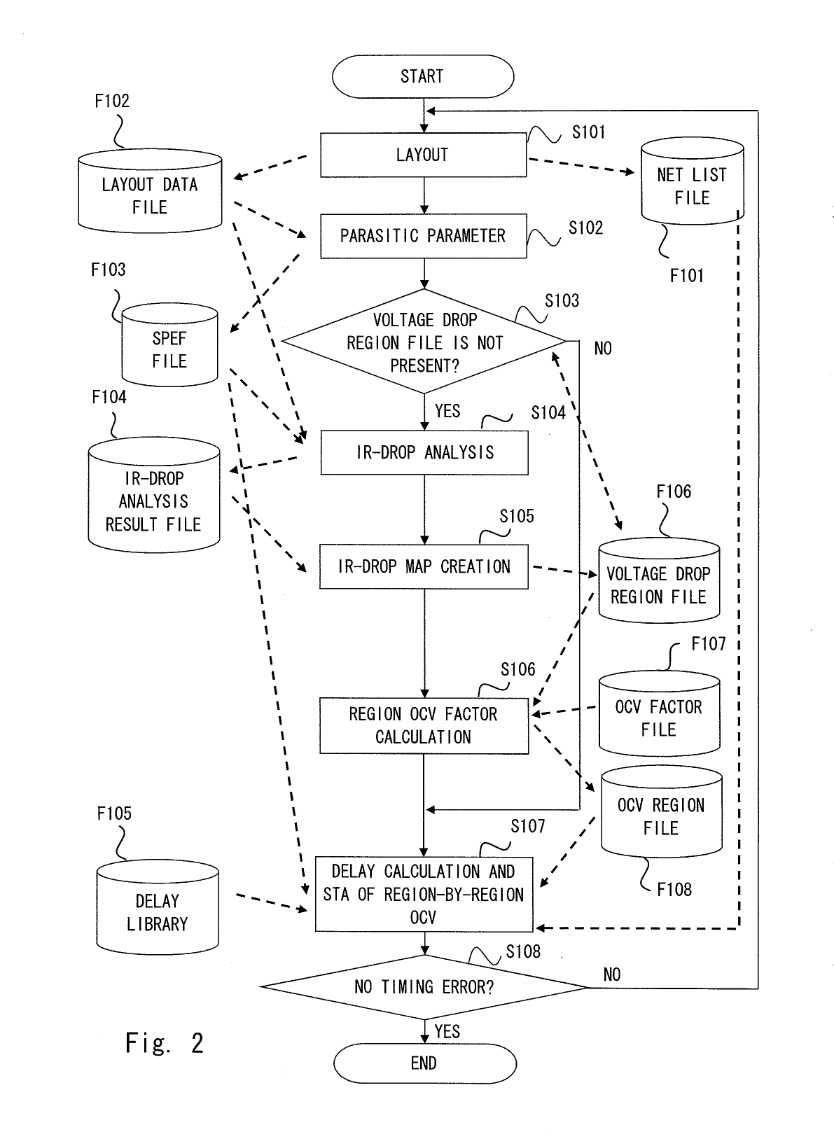

A timing analysis method by the timing analysis apparatus according to the embodiment is described hereinafter with reference to FIG. 2. FIG. 2 is a flowchart showing a procedure of timing analysis by the timing analysis apparatus. Although the case where the timing analysis is executed according to a timing analysis program read by the processing unit 309 of the computer device 306 in the timing analysis apparatus is described below by way of illustration, the timing analysis may be executed according to a timing analysis program read by the processing unit 302 of the server 301.

First, in Step S101, layout is performed. In Step S101, the processing unit 309 lays out the arrangement of instances and lines to connect the instances in an actual integrated circuit on a semiconductor chip, and outputs physical information about instances (the coordinates and shape of an instance, the shape of a line connecting an instance etc.) to a layout data file (F102).

The layout data file (F102) contains physical information indicating where on a semiconductor chip instances are arranged and what shape of lines the instances are connected by as the layout. In this embodiment, the layout data file (F102) may be output in a common output format such as DEF(Design Exchange Format)/LEF(Library Exchange Format) stated in OpenEDA (OpenEDA: https://www.si2.org/openeda.si2.org/projects/1efdef), for example.

Further, the processing unit 309 outputs logical information about instances (information of an instance, terminal information of an instance, connection information between terminals etc.) to a net list file (F101). The information of an instance includes the coordinates and shape on a semiconductor chip, the name of an instance, the cell name of an instance, the terminal name of an instance, and information indicating the connection between terminals. Note that the cell means a circuit block such as an AND circuit, for example. Further, the “instance” is a name uniquely assigned for identifying a specific cell, which is used to distinguish between the cells which are identical but located in different places or connected by different lines.

Next, in Step S102, extraction of a parasitic parameter is performed. The extraction of a parasitic parameter performed in Step S102 is common parasitic parameter extraction processing. The processing unit 309 extracts a parasitic resistance and a parasitic capacitance from the shape of the line written in the layout data file (F102) by using the layout data file (F102) output in Step S101 as input, and outputs the extracted parasitic parameter to a SPEF file (F103).

The SPEF file (F103) is a file in a commonly known format. SPEF of the SPEF file (F103) stands for Standard Parasitic Exchange Format. The format of the SPEF file (F103) is defined by the IEEE standard group. The SPEF file (F103) contains the parasitic capacitance and the parasitic resistance of each line.

Then, in Step S103, the presence of a voltage drop region file (F106) is checked. The processing unit 309 determines the presence or absence of the voltage drop region file (F106) and, according to the determination result, makes a conditional branch for the subsequent processing. Because the voltage drop region file (F106) is not present in the initial state in the timing analysis, the process proceeds to IR-Drop analysis in Step S104. When, on the other hand, the voltage drop region file (F106) is created in Step S105, which is described later, the process proceeds to delay calculation and STA processing of region-by-region OCV in Step S107, without performing the processing of S104 to S106.

Then, in Step S104, IR-Drop analysis is performed. The IR-Drop analysis performed in Step S104 is common IR-Drop analysis processing. The processing unit 309 performs voltage drop analysis of circuits (instances and their connection information) which are laid out on the semiconductor chip. Specifically, the processing unit 309 performs the IR-Drop analysis by using the layout data file (F102) output in Step S101 and the SPEF file (F103) output in Step S102 as input, and thereby analyzes voltage drop in the semiconductor chip. The processing unit 309 outputs an analysis result of voltage drop in the semiconductor chip to an IR-Drop analysis result file (F104).

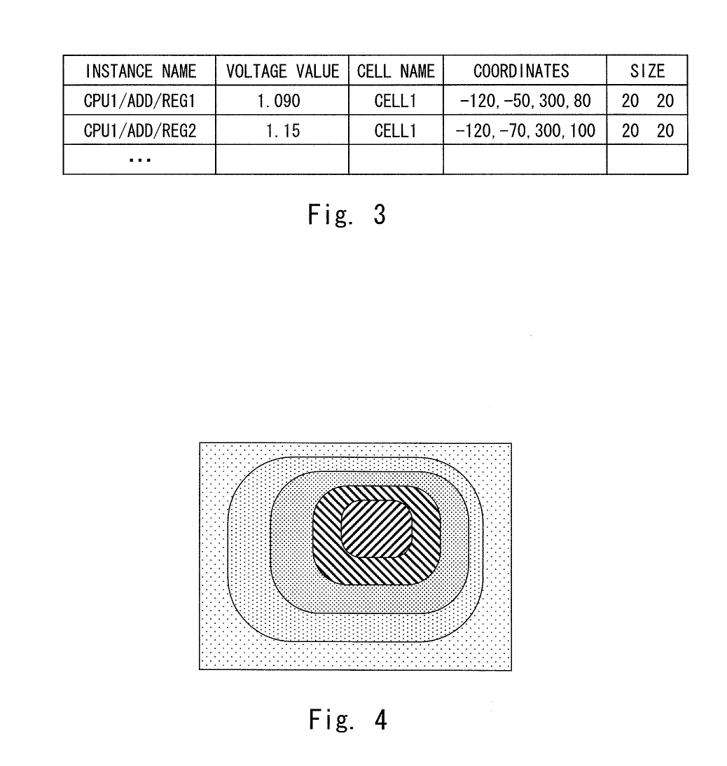

The IR-Drop analysis is to analyze voltage drop occurring in the semiconductor chip. The IR-Drop analysis result file (F104) contains an instance name, the voltage value of an instance, the cell name of an instance, the coordinates of an instance, and the shape (size) of an instance. FIG. 3 shows an output example of the IR-Drop analysis result file (F104). In FIG. 3, “CPU1/ADD/REG1” is written as the instance name, “1.090V” is written as the voltage value of the instance, “CELLA” is written as the cell name, “−120,−50,300,80” is written as the coordinates, and “20 20” is written as the size, for example.

Then, in Step S105, IR-Drop map creation is performed. In Step S105, voltage drop region file (F106) creation is performed as the IR-Drop map creation. The processing unit 309 creates the voltage drop region file (F106) in which voltage drop on the semiconductor chip is written as regions at given voltage ranges based on the result of the voltage drop analysis. Specifically, using the IR-Drop analysis result file (F104) output in Step S104 as input, the processing unit 309 creates the voltage drop region file (F106) from the IR-Drop analysis result file (F104). The processing unit 309 outputs information indicating in which region and by what voltage the voltage drop on the semiconductor chip occurs to the voltage drop region file (F106).

The IR-Drop analysis result file (F 104) contains the instance name, the voltage value of an instance, the cell name of an instance, the coordinates of an instance, and the shape (size) of an instance as illustrated in FIG. 3. FIG. 4 is a view conceptually representing the information contained in the IR-Drop analysis result file (F104) as regions on the semiconductor chip. As shown in FIG. 4, the voltages of instances where voltage drop from the power supply voltage has occurred are displayed as a gradation, so that the distribution of the voltages in the semiconductor region can be represented.

In this embodiment, in Step S105, the processing unit 309 outputs the priorities of regions, the voltage values of regions and the coordinates of regions to the voltage drop region file (F106), so that the regions represented in the semiconductor are rectangular regions. To be more specific, the processing unit 309 first finds a region where the largest voltage drop occurs by referring to the IR-Drop analysis result file (F104), sets the priority of the region as 1, obtains the voltage of the region and the coordinates (lower left and upper right) of the rectangular region, and outputs them to the voltage drop region file (F106). After that, in the same manner, the processing unit 309 finds a region where the second largest voltage drop occurs, sets the priority of the region as 2, obtains the voltage of the region and the coordinates of the rectangular region, and outputs them to the voltage drop region file (F106).

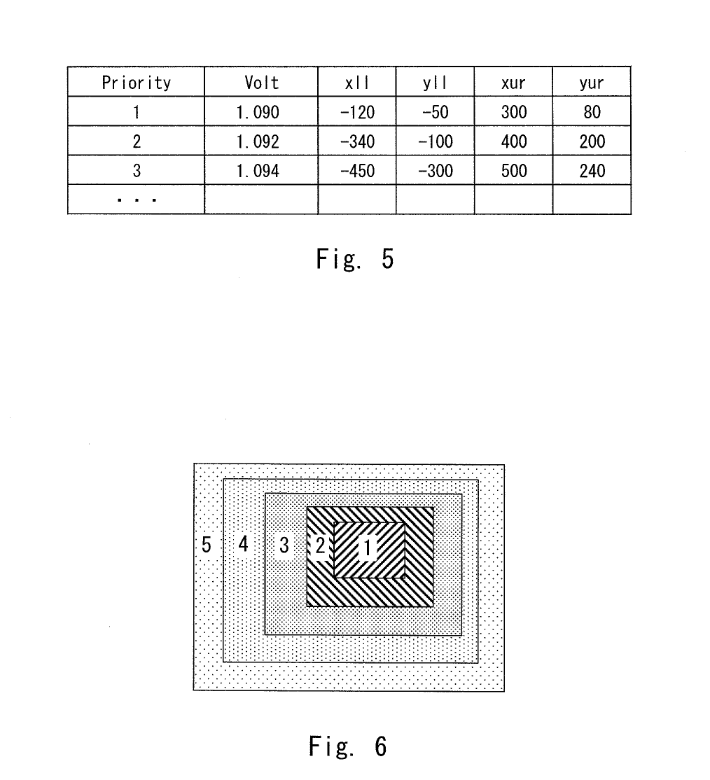

Hereinafter, the voltage drop region file (F106) according to the embodiment is specifically described with reference to FIGS. 5 and 6. FIG. 5 shows an output example of the voltage drop region file (F106). As shown in FIG. 5, the voltage drop region file (F106) contains the priority of a region (Priority), the voltage value of a region (Volt), and the coordinates of a region (x11, y11, xur, yur) in each row. In the voltage drop region file (F106), the priorities of regions are contained in the first column, the voltage values of regions are contained in the second column, and the coordinates of regions are contained in the third to sixth columns. Note that, in the example of FIG. 5, the voltage values of regions are grouped into every 0.02V range, and the unit of grouping is the same as the unit in which the voltage values of instances shown in FIG. 3 are described.

As for the priority of a region, a higher priority is assigned to a region with a lower voltage value due to the effect of voltage drop in the semiconductor region. For example, the priority of a region with the lowest voltage due to the effect of voltage drop is 1, and the priority of a region with the second lowest voltage is 2, and the priorities are set in this manner. Note that, when the next lowest voltage value is the power supply voltage value, the priority of the region is the least.

Further, in this embodiment, because the regions are represented by a rectangle, the coordinates of a region (x11, y11, xur, yur) for identifying the region are represented using the coordinates of the lower left corner and the upper right corner (the lower left x-coordinate, the lower left y-coordinate, the upper right x-coordinate and the upper right y-coordinate) of the rectangular region.

It should noted that, although the regions are represented as rectangle regions so as to simplify processing in this embodiment, it is not limited thereto, and the regions may be represented by another shape such as an elliptical shape, for example. Further, although the priorities are set to the regions so as to easily identify in which region an instance is included even when the regions are in inclusive relation in this embodiment, it is also not limited thereto. For example, when the regions are in inclusive relation, it is feasible to set a region with the lowest voltage as a first region, a region with the second lowest voltage and surrounding the first region as a second region, and a region with the third lowest voltage and surrounding the second region as a third region, and then enter the voltage values of the respective regions, including the first region, the second region outside of the first region, and the third region outside of the second region, into the voltage drop region file (F106).

FIG. 6 is a view conceptually representing information contained in the voltage drop region file (F106) as regions on a semiconductor chip. As shown in FIG. 6, the distribution of the voltage in the semiconductor region can be represented by rectangular regions to which priorities are assigned.

Next, in Step S106, OCV factor calculation is performed. The processing unit 309 calculates OCV factors corresponding to the given voltage ranges contained in the voltage drop region file (F 106) for each of the regions by using an OCV factor file (F107), and creates an OCV region file (F108) that contains the calculated OCV factors and the regions in association with each other. To be more specific, using the voltage drop region file (F106) output in Step S105 and the OCV factor file (F107) as input, the processing unit 309 calculates the values of OCV factors (which may be hereinafter referred to simply as OCV values) corresponding to the voltage values in the voltage drop region file (F 106) from the voltage drop region file (F106) and the OCV factor file (F107), and outputs the calculated OCV values to the OCV region file (F108).

The OCV value is briefly described hereinbelow. OCV stands for On Chip Variation. The OCV indicates variation of delay time depending on the characteristics of an element on a semiconductor chip (cf. e.g. http://techon.nikkeibp.co.jp/article/WORD/20090107/163763/). Typically, a delay factor “α(late)” when variation in the later direction occurs by OCV and a delay factor “β(early)” when variation in the earlier direction occurs by OCV are prepared in advance as the factors of the OCV. Then, for an element whose timing becomes tight when variation in the later direction occurs in the circuit being inspected, its delay value is multiplied by α(late). On the other hand, for an element whose timing becomes tight when variation in the earlier direction occurs, its delay value is multiplied by β(early). Under such conditions, timing verification using STA is carried out. By working out a design so as to meet timing by the timing verification under such conditions, the operation can be guaranteed even if variation occurs in the element due to OCV. The factor used in the timing verification is called a derating factor or an OCV factor.

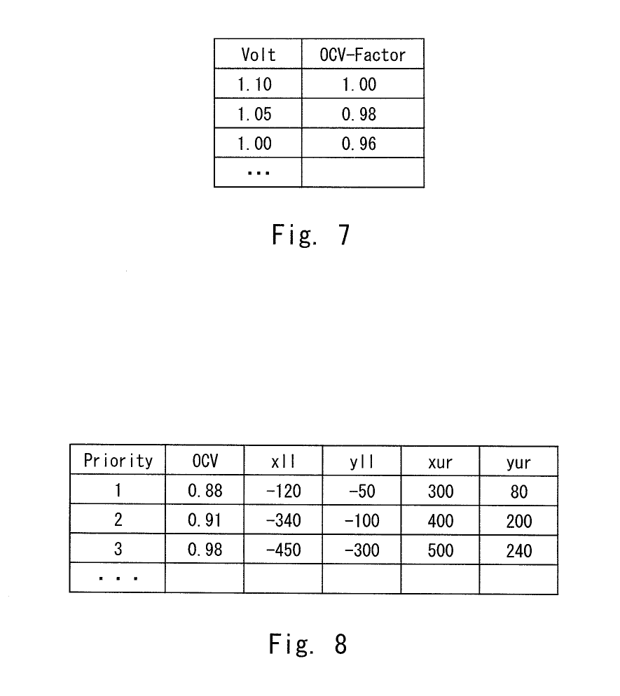

The OCV factor file (F107) contains voltage values and OCV factors corresponding to the voltage values. FIG. 7 shows an example of the OCV factor file (F107). As shown in FIG. 7, in the OCV factor file (F107), the voltage value (Volt) and the OCV factor (OCV-Factor) are written in each row in steps of every given voltage. In the example of FIG. 7, the voltage value and the OCV factor corresponding to the voltage value are written in each row in steps of 0.05V.

Although the two values a and 13 exist as the delay factor as described above, in this embodiment, the delay factor is represented using one OCB value, assuming that a and are the same value. Further, in this embodiment, OCV values respectively corresponding to a plurality of voltage values in consideration of voltage drop are prepared as the OCV value contained in the OCV factor file (F107), not using an OCV value for representing variation of delay at a fixed voltage. Appropriate values of those OCV values are pre-calculated and pre-stored into the recording medium 308 or the like as the OCV factor file (F107).

The OCV region file (F108) is a file in which OCV values are written with respect to each region where voltage drop has occurred. The OCV region file (F108) contains the priority of a region (Priority), the OCV value of a region (OCV), and the coordinates of a region (x11, y11, xur, yur) in each row.

A specific example of the OCV factor calculation is described hereinafter by taking the case of outputting the OCV region file (F108) using the voltage drop region file (F106) illustrated in FIG. 5 and the OCV factor file (F107) illustrated in FIG. 7 as an example. First, for the region having the priority 1 shown in FIG. 5, because the voltage of the region is 1.090V, an OCV value at 1.090V is calculated by interpolation using the OCV value (1.00) at 1.10V and the OCV value (0.98) at 1.05V among the voltage values shown in FIG. 7. Then, the voltage value in the voltage drop region file (F 106) shown in FIG. 5 is substituted by the calculated OCV value and output to the OCV region file (F108). In the same manner, for the next row containing information about the region having the second highest priority, an OCV value corresponding to the voltage value in the voltage drop region file (F 106) is calculated by interpolation using the voltage values and the OCV values contained in the OCV factor file (F107), and the voltage value in the voltage drop region file (F106) is substituted by the calculated OCV value and output to the OCV region file (F108). In this manner, the voltage values in all rows of the voltage drop region file (F106) are respectively substituted by the calculated OCV values and output to the OCV region file (F108).

FIG. 8 shows an output example of the OCV region file (F108). The OCV value (OCV) shown in FIG. 8 is a result of substituting the voltage values in the voltage drop region file (F106) illustrated in FIG. 5 by the OCV values using the OCV factor file (F107) illustrated in FIG. 7.

Then, delay calculation and STA processing of region-by-region OCV are performed in Step S107. The processing unit 309 performs delay calculation and STA processing of region-by-region OCV by using the SPEF file (F103) output in Step S102, the delay library (F105), the OCV region file (F108) output in Step S106, and the net list file (F101) output in Step S101 as input, and thereby performs timing analysis. Note that the details of the processing in S107 are described later.

Then, in Step S108, the presence of a timing error in Step S107 is checked. The processing unit 309 determines the presence or absence of a timing error and, according to the determination result, makes a conditional branch for the subsequent processing. When the processing unit 309 determines in Step S108 that there is no timing error, the process ends. On the other hand, when the processing unit 309 determines that there is a timing error, the process returns to Step S101 and continues processing.

A procedure to be executed when it is determined in Step S108 that there is a timing error is briefly described hereinbelow.

First, in the layout of S101, the processing unit 309 modifies the layout of a timing error location and overwrites the layout data file (F102) and the net list file (F101) with the modified result.

Next, in the parasitic parameter extraction of Step S102, the processing unit 309 extracts a parasitic parameter from the layout data file (F102) modified in Step S101, and outputs the extracted parasitic parameter to the SPEF file (F103).

Then, in the conditional branch of Step S103, the processing unit 309 checks the presence of the voltage drop region file (F106). Because the voltage drop region file (F106) is already created, the processing unit 309 makes the process proceed to Step S107 and performs timing analysis through delay calculation and STA processing of region-by-region OCV.

Then, in the conditional branch of Step S108, the processing unit 309 checks the presence or absence of a timing error in Step S107, and, when there is an error, the process returns to Step S101 and modifies the layout in the same manner. When there is no timing error in Step S108, the process ends.

In this manner, the processing of Steps S101, S102, S103, S107 is performed repeatedly until no timing error is found in Step S107.

Note that, by the conditional branch of Step S103, the processing of Steps S104 to S106 is performed for the first time only in the timing analysis process illustrated in FIG. 2, and the processing of Steps S104 to S106 is not repeatedly performed after the second time. Therefore, after the IR-Drop analysis is already performed and the voltage drop region file (F106) is once created, the creation of the voltage drop region file (F106) and the IR-Drop analysis for creating the voltage drop region file (F106) are not performed, thereby allowing reduction of the processing time needed for timing analysis.

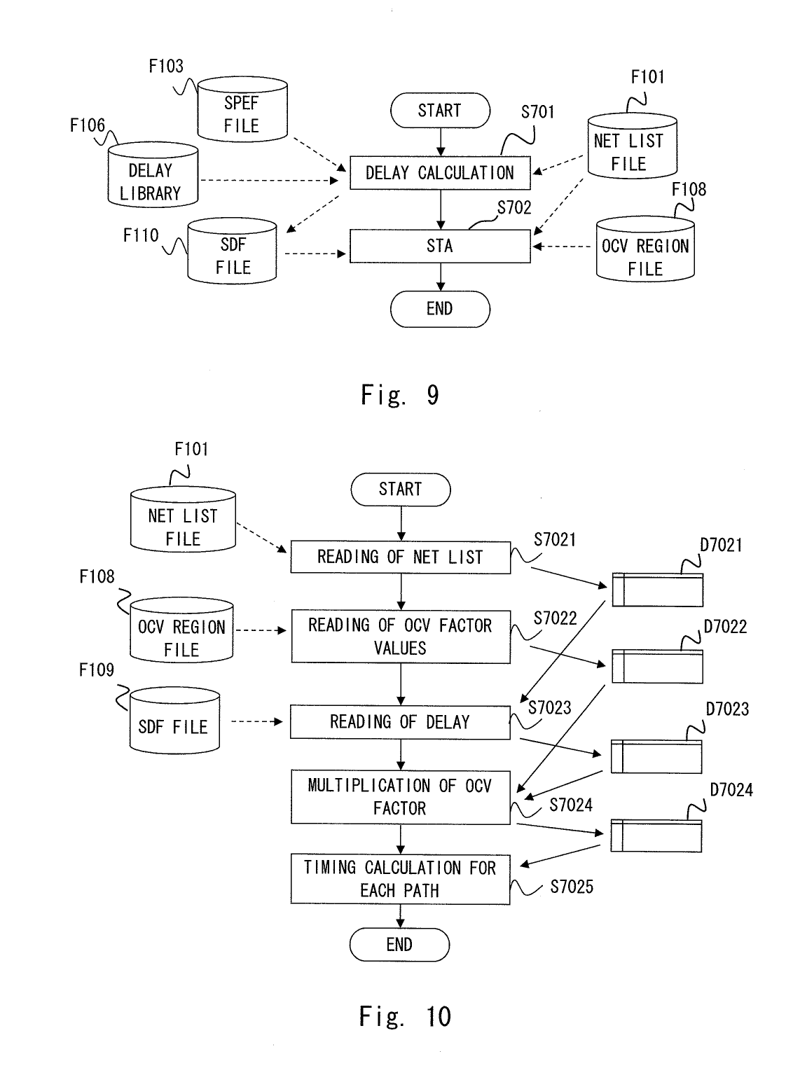

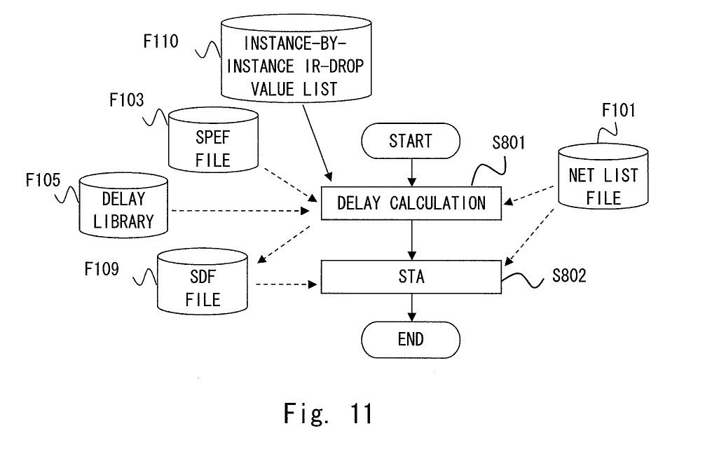

The details of the delay calculation and STA processing of region-by-region OCV in Step S107 are described hereinafter with reference to FIGS. 9 and 10.

FIG. 9 is a flowchart showing a more detailed procedure of the delay calculation and STA processing of region-by-region OCV in Step S107.

First, in Step S701, delay calculation is performed. The delay calculation performed in Step S701 is common delay calculation processing. The processing unit 309 calculates information of an instance, terminal information of an instance, and connection information between terminals from the net list file (F101) output in Step S101, reads the SPEF file (F103) output in Step S102 and the delay library (F105), performs delay calculation at the voltage value of the delay library, and outputs the delay value of each instance and the delay value of each line to an SDF file (F109). Voltage drop of an instance is not taken into account in common delay calculation, and voltage drop is not taken into account also in the delay calculation according to the embodiment.

SDF of the SDF file (F109) stands for Standard Delay Format. The format of the SDF file (F 109) is defined by the IEEE standard group. The SDF file (F109) contains the delay value of each instance and the delay value of each line.

Then, in Step S702, STA processing is performed. The processing unit 309 performs timing analysis of the laid-out circuit using a result of the delay calculation and the region-by-region OCV value contained in the OCV region file (F108). Specifically, the processing unit 309 reads the SDF file (F109) output in Step S701, the net list file (F101) output in Step S101, and the OCV region file (F108) output in Step S106, and performs timing analysis.

FIG. 10 is a flowchart showing a more detailed procedure of STA processing in Step S702.

First, in Step S7021, reading the net list file (F101) is performed. The processing unit 309 reads the net list file (F101) output in Step S101 and stores the instance information, terminals of instances, and connection information between terminals as data D7021.

Next, in Step S7022, reading of the OCV factor is performed. The processing unit 309 reads the OCV region file (F108) output in Step S106 and stores it as data D7022. As illustrated in FIG. 8 described above, the OCV region file (F108) is represented as two-dimensional data, six columns in each row. In FIG. 8, the first row contains “1” as the priority of a region, “1.00” as the OCV value, “−120” as the lower left x-coordinate, “−50” as the lower left y-coordinate, “300” as the upper right x-coordinate, and “80” as the upper right y-coordinate, for example.

Next, in Step S7023, reading of the delay calculation is performed. The processing unit 309 reads the SDF file (F109) output in Step S701, adds the delay values of instances and the delay values of lines contained in the read SDF file (F109) to the data D7021 and stores them as data D7023. To be more specific, the processing unit 309 adds the delay values of instances in the SDF file (F109) to the instance information of the data D7021, adds the delay values of lines in the SDF file (F109) to the connection information between terminals of the data D7021, and stores them as data D7023. The data D7023 contains all delay values of instances and all delay values of lines between terminals connecting instances.

Next, in Step S7024, multiplication of the OCV factor is performed. For the delay value of an instance and the delay value of a line contained in the data D7023, the processing unit 309 retrieves the OCV value of a region in which the instance is included among the OCV values contained in D7022, multiplies the delay value by the retrieved OCV value, and stores a result as data D7024. To be more specific, for the delay value of an instance and the delay value of a line contained in the data D7023, the processing unit 309 retrieves the OCV value of the relevant region from the coordinates of the instance by referring to the priority and the coordinates contained in the data D7022, multiplies the delay value contained in D7023 by the OCV value of the retrieved region, and outputs and stores the delay value after the multiplication to the data D7024. When retrieving the relevant OCV value from the coordinates of the instance and the OCV value of the region in the data D7022, a commonly known high-speed search technique may be used, and the OCV value of the region involving the coordinates of the instance is retrieved at high speed.

Next, in Step S7025, timing calculation with respect to each PATH is performed. The processing unit 309 performs timing calculation with respect to each path to be inspected, using the delay value multiplied by the OCV value in the OCV factor multiplication in Step S7024 (the OCV value contained in the data D7024). The processing unit 309 analyzes the validity of a clock signal and a data signal with respect to each path. To be more specific, the processing unit 309 calculates the arrival time of a clock signal and a data signal from the delay value by referring to the instance information and the connection information between terminals of the instance stored in the data D7024, and analyzes whether it satisfies the constraints on the arrival time. As a result of the analysis, when the constraints on the arrival time are not satisfied, the processing unit 309 outputs it as an error.

According to the embodiment described above, because the regions where voltage drop has occurred are set respectively at given voltage ranges, and timing analysis can be performed using the OCV values calculated for the respective regions, it is possible to reduce the processing time of delay calculation compared with the timing analysis technique with voltage drop taken into account according to related art. It is thereby possible to reduce the processing time needed for the entire timing analysis process. The reason is described specifically below.

First, in order to reflect the voltage drop, IR-Drop map creation is performed in Step S105 shown in FIG. 2.

The IR-Drop map creation of Step S105 creates the voltage drop region file (F106). The voltage drop region file (F106) represents the IR-Drop analysis result file (F104) as the regions on the semiconductor chip. Because the voltage drop region file (F106) is a file that merely indicates the regions on the semiconductor chip, the file size can be small.

Further, the IR-Drop map creation of Step S105 is processing of setting the regions by grouping the analysis results of voltage drop into given voltage ranges and determining the boundaries of the respective grouped voltage ranges. This processing determines the boundaries of the voltage ranges from a result of reading the IR-Drop analysis result file (F104) and outputs them to the voltage drop region file (F106). The processing can be thereby performed with substantially no increase in processing time compared with that needed to read the IR-Drop analysis result file (F104).

Then, in Step S106, the voltage values contained in the voltage drop region file (F106) are converted into the OCV values using the OCV factor file (F107) and then output as the OCV region file (F108). This is a simple process of substituting the voltage values defined for the respective regions on the semiconductor chip with the OCV values by interpolation. The file size of the OCV region file (F108) is equal to the file size of the voltage drop region file (F106). Accordingly, although the processing time to handle a small file size is needed to carry out the processing of Step S106, an increase in processing time is only several seconds.

Then, in Step S107, delay calculation and STA processing of region-by-region OCV are performed. To be more specific, delay calculation without consideration of voltage drop is performed in Step S701 shown in Fig, 9, and then STA is performed in Step S702 by identifying the region in the OCV region file (F108) from the coordinates of an instance and retrieves its OCV value, and multiplying the delay value by the retrieved OCV value as a factor. Thus, in this embodiment, the processing of reflecting the analysis result of voltage drop in STA is, not done in the procedure that the analysis result of voltage drop is obtained by interpolation using a plurality of delay libraries. There is thus no need to perform delay calculation with voltage drop taken into account. The procedure according to this embodiment is: represent the analysis result of voltage drop as the regions on the semiconductor chip, substitute the analysis result of voltage drop by the OCV factors for the respective regions, and reflect the OCV factors in STA.

Further, as described above, the delay calculation in Step S701 shown in FIG. 9 is common delay calculation processing. Because the delay calculation in Step S701 is delay calculation without consideration of voltage drop, the processing time needed for delay calculation is short. In this embodiment, it takes several seconds of processing time to perform reading of a small file in the OCV factor reading in Step S7022 shown in FIG. 10. Further, the processing time increases to perform processing of retrieving the OCV value by reference to the data D7023 from the coordinates of an instance in the OCV factor multiplication in Step S7024. However, because each processing handles a file with a small file size, necessary computation time is short. Note that, although searching is needed when retrieving the OCV value by reference to the data D7022, by use of a commonly known high-speed search technique (e.g. hash search), the processing time that increases as a result of performing the OCV factor multiplication in Step S7024 can be as low as 1% or less. It is thereby possible to perform timing analysis with a less processing time for delay calculation.

Therefore, according to the embodiment, the delay calculation time can be reduced without a decrease in accuracy. At the same time, because the OCV region file (F108) with a small file size is created and voltage drop in each region in the OCV region file (F108) is taken into account as the OCV value in this embodiment, timing calculation with voltage drop taken into account can be performed in STA processing with a minimum increase in processing time. It is thereby possible to reduce the processing time needed for delay calculation and thereby reduce the processing time needed for timing analysis as a whole.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A timing analysis method comprising:
a voltage drop analysis step of performing voltage drop analysis of a circuit laid out on a semiconductor chip;
a voltage drop region file creation step of creating a voltage drop region file representing voltage drop on the semiconductor chip as regions at given voltage ranges based on a result of the voltage drop analysis;
a variation region file creation step of calculating second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other;
a delay calculation step of performing delay calculation of the laid-out circuit by using a delay library; and
a timing analysis step of performing timing analysis of the laid-out circuit by using a result of the delay calculation and the second variation factors for each of the regions contained in the variation region file.

2. The timing analysis method according to claim 1, wherein the timing analysis step includes:
a variation factor multiplication step of retrieving a third variation factor of a region relevant to a result of the delay calculation among the second variation factors for each of the regions contained in the variation region file, and multiplying the result of the delay calculation by the retrieved third variation factor; and
a timing calculation step of performing timing calculation for each path to be inspected based on the result of the delay calculation multiplied by the third variation factor.

3. The timing analysis method according to claim 1, wherein, when the variation region file is created once in the variation region file creation step performed for the first time, the timing analysis is performed by using the created variation region file in the subsequent timing analysis step.

4. The timing analysis method according to claim 1, wherein, when creating the voltage drop region file in the voltage drop region file creation step, the regions to be contained into the voltage drop region file are represented by a rectangular shape, and priorities depending on voltage drop in each region are assigned to the regions and contained into the voltage drop region file.

5. A timing analysis apparatus comprising:
a voltage drop analysis unit that performs voltage drop analysis of a circuit laid out on a semiconductor chip;
a voltage drop region file creation unit that creates a voltage drop region file representing voltage drop on the semiconductor chip as regions at given voltage ranges based on a result of the voltage drop analysis;
a variation region file creation unit that calculates second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other;
a delay calculation unit that performs delay calculation of the laid-out circuit by using a delay library; and
a timing analysis unit that performs timing analysis of the laid-out circuit by using a result of the delay calculation and the second variation factors for each of the regions contained in the variation region file.

6. The timing analysis apparatus according to claim 5, wherein the timing analysis unit includes:
a variation factor multiplication unit that retrieves a third variation factor of the region relevant to a result of the delay calculation among the second variation factors for each of the regions contained in the variation region file, and multiplies the result of the delay calculation by the retrieved third variation factor; and
a timing calculation unit that performs timing calculation for each path to be inspected based on the result of the delay calculation multiplied by the third variation factor.

7. The timing analysis apparatus according to claim 5, wherein, when the variation region file creation unit has once created the variation region file, the timing analysis unit subsequently performs the timing analysis by using the created variation region file.

8. The timing analysis apparatus according to claim 5, wherein, when creating the voltage drop region file, the voltage drop region file creation unit represents the regions to be contained into the voltage drop region file by a rectangular shape, and assigns priorities depending on voltage drop in each region to the regions.

9. A non-transitory computer readable medium storing a timing analysis program causing a computer to execute a process comprising:
performing voltage drop analysis of a circuit laid out on a semiconductor chip;
creating a voltage drop region file representing voltage drop on the semiconductor chip as regions at given voltage ranges based on a result of the voltage drop analysis;
calculating second variation factors respectively corresponding to the given voltage ranges contained in the voltage drop region file for each of the regions by using a variation factor file containing first variation factors representing variation of delay in association with given voltages in consideration of voltage drop, and creating a variation region file containing the calculated second variation factors and the regions in association with each other;
performing delay calculation of the laid-out circuit by using a delay library; and
performing timing analysis of the laid-out circuit by using a result of the delay calculation and the second variation factors for each of the regions contained in the variation region file.
